(19) United States
(12) Patent Application Publication
(10) Pub. No.: US 2017/0364985 A1
(43) Pub. Date: Dec. 21, 2017

(54) ORDERING AND ORDER RECEIVING SYSTEM FOR FISH AND SHELLFISH

(71) Applicant: Ohta Foods Market Co., Ltd., Tokyo (JP)

(72) Inventor: Hidehiko Ohta, Tokyo (JP)

(73) Assignee: Ohta Foods Market Co., Ltd., Tokyo (JP)

(21) Appl. No.: 15/500,988

(22) PCT Filed: Feb. 20, 2015
(86) PCT No.: PCT/JP2015/000818

§ 371 Date: Feb. 1, 2017

(51) Int. Cl. G06Q 30/06; G06Q 10/08; G06Q 30/04; G06Q 50/02

(52) U.S. Cl. CPC G06Q 30/0623; G06Q 50/02; G06Q 10/083; G06Q 10/0875; G06Q 30/04

(57) ABSTRACT

There is provided an ordering and order receiving system for fish and shellfish, capable of achieving an ingenious transaction type that can be performed due to an electronic transaction using computers.

When each of the ordering clients inputs ordering data into the order receiving server, the server forms order receiving data based on customer information according to the ordering data and commodity information on fishes and shellfishes for which an order has been received, and also forms stocking data and shipping data based on the order receiving data so as to output the pieces of data to a management client in fish and shellfish management section. The management client prepares at least a shipping direction, a statement of delivery, and a bill, or a document equivalent to the documents for the fishes and shellfishes for which the order has been received from each customer, and also forms a stocking instruction for the fishes and shellfishes for which the order has been received, based on the input stocking data and shipping data. The management section packs and ships the fishes and shellfishes that have been stocked based on the instruction, to each of the customers.

### TECHNICAL FIELD

The present invention relates to an ordering and order receiving system for fish and shellfish. In the ordering and order receiving system for fish and shellfish, instead of visiting a market, such as the Tsukiji Market, a customer can place an order, based on desired fishes and shellfishes, those desired quantities, those desired prices, and the like, from an order receiving server operated by a broker or the like, through a client terminal, at hand, disposed at a customer's company, a store, or the like. In the order receiving server that has received the order, instructions for packing and shipping fishes and shellfishes for which an order has been received every customer can be given to a fish and shellfish management section.

### BACKGROUND ART

Conventionally, a number of suggestions have been made for transaction methods and trading systems for fresh fish and shellfish by electronic means, according to Patent Literature 1 to 4.

The electronic transaction methods and electronic trading systems for fresh fish and shellfish conventionally suggested in Patent Literature 1 to 4 have an advantage that a person who desires to purchase fish and shellfish is not required to visit a market, such as the Tsukiji Market, because a computer and a network are used. However, the electronic transaction methods and electronic trading systems are transaction types different from a buying and selling type actually made by watching and touching fishes and shellfishes at the market. Therefore, the electronic transaction methods and electronic trading systems have not become widespread well.

The invention disclosed in each of Patent Literature 1 to 4 is an electronic transaction using the computer and the network. However, the invention is not regretfully an ingenious transaction type that sufficiently, effectively uses characteristics of an electronic transaction and can be achieved due to the electronic transaction.

Meanwhile, Japan External Trade Organization (JETRO) has proposed measures for promoting export of agricultural, forestry and fishery products. Export of fresh fish and shellfish has been performed to Hong Kong and Singapore in accordance with the measures. However, management of fish and shellfish including stocking, packing, and shipping of the fish and shellfish in the export follows a method substantially the same as that of conventional management for home. When an amount of export increases and an overseas outlet expands to regions other than the above regions, it is actually impossible to achieve prompt packing and shipping to be in time for departure times of a limited number of cargo air services. However, when an electronic ordering and order receiving system is effectively used, it becomes possible to achieve prompt packing and shipping indispensable for exporting fresh fish and shellfish because necessary export documents can be prepared inside the system even in a case where an amount of export increases and an outlet expands. Thus, it is thought that the following epoch-making effect can be expected. That is, it becomes possible to relish fishes the same as fishes and shellfishes to be consumed at home, within the same day in Southeast Asian countries and the like other than Hong Kong and Singapore described above.

### CITATION LIST

### Patent Literature

Patent Literature 1: JP 4471296 B2
Patent Literature 2: JP 4589590 B2
Patent Literature 3: JP 2004-206432 A
Patent Literature 4: JP 2004-362122 A

### SUMMARY OF INVENTION

### Technical Problem

An objective of the present invention is to provide an ordering and order receiving system for fish and shellfish, capable of achieving an ingenious transaction type that can be performed due to an electronic transaction using comₚuters, by focusing on a point that a server on the side of order receiving and a client on the side of ordering are the computers that are coupled through a network including the Internet and are capable of a freely exchange of information and management processing of the exchanged information.

### Solution to Problem

A configuration of the ordering and order receiving system according to the present invention that has been made in order to solve the above problems, includes: an order receiving server configured to produce commodity information on fishes and shellfishes that can be provided to ordering clients of a plurality of customers on that day (from 15 o'clock on the previous day to 1 o'clock or 2 o'clock on the day) , the order receiving server configured to form order receiving data based on ordering data of each of the customers, formed by specifying desired fishes and shellfishes through the individual clients by the customers who have watched the produced information, the order receiving server configured to form stocking data on the day and shipping data for each of the customers based on the order receiving data, and the order receiving server configured to output the stocking data and the shipping data for each of the customers to a fish and shellfish management section that stocks the fishes and shellfishes and that packs and ships the stocked fishes and shellfishes; and the ordering clients of the plurality of customers configured to output the ordering data specifying the desired fishes and shellfishes based on the commodity information produced on a client screen of each of the customers by the order receiving server, to the server. The order receiving server includes: a recording unit for customer information including customer classification formed based on customer attributes, such as a category of business, a scale, and a location of each of the customers being the ordering clients; a recording unit for the commodity information including categories of the fishes and shellfishes, commodity character, such as figures, names, sizes, prices, and places of origin in each of the categories, and classification character, such as seasonal fish, standard fish, and recommended fish, the commodity information being produced to the clients; a commodity information selecting unit configured to select commodity information to be displayed on the client screen of each of the customers based on the customer information and the commodity information in the recording units; a display instructing unit configured to display the selected commodity information on the client screen; an order receiving data forming unit configured to form and retain the order receiving data per unit customer by associating the ordering data with the customer information for the order, the ordering data being selected from the commodity information displayed on the screen and being output from the clients; a stocking data forming unit configured to form the stocking data of the fishes and shellfishes required to be stocked based on the order receiving data per unit customer; a shipping data forming unit configured to form the shipping data for preparing shipping documents at least, such as a shipping direction, a statement of delivery, and a bill for each of the customers based on the order receiving data; and a communication unit coupled to output of the display instructing unit, the order receiving data forming unit, and the shipping data forming unit. When each of the ordering clients inputs the ordering data into the order receiving server, the server forms the order receiving data based on the ordering data and also forms the stocking data and the shipping data based on the order receiving data so as to output the pieces of data to a management client in the fish and shellfish management section. The management client prepares the shipping documents or a document equivalent to the documents for the fishes and shellfishes for which the order has been received from each of the customers, and also forms a stocking instruction for the fishes and shellfishes for which the order has been received, based on the input data. The management section stocks the fishes and shellfishes based on the stocking instruction, and also packs and ships the fishes and shellfishes that have been stocked, to each of the customers.

According to the present invention, the commodity information display instructing unit displays the commodity information on contents selected based on the customer classification of the customer information, on the client screen of each of the classified customers.

According to the present invention, the commodity information to be selected can be selected based on any of the categories of the fishes and shellfishes, the classification character of customer orientation, such as seasonal fish, standard fish, and recommended fish, and the prices of the fishes and shellfishes, or a combination thereof.

According to the present invention, the ordering clients can be considered to be one ordering client (united client or main office, head office) uniting the plurality of customers (branches). Meanwhile, the order receiving data from the client as unity can be formed per unit united customer. The shipping data can be united with the order receiving data per unit customer. The shipping data can be formed to be one shipping direction, one statement of delivery, and one bill, or the document equivalent thereto, for the united client (main office, head office). Then, the shipping data can be output to the united client and the fish and shellfish management section.

Furthermore, according to the present invention, the following configuration can be accepted in order to handle ordering from overseas. That is, the commodity information displayed on each client screen by the commodity information display unit can be displayed by switching between Japanese and a foreign language including at least English, corresponding to the Japanese. In addition to the configuration, the order receiving data forming unit is individually formed for domestic customers and for overseas customers.

When the commodity information is displayed on each client screen in the foreign language for the overseas customers, a preparing unit (export document preparing unit) for documents at least, such as an invoice, a packing list, a certificate of origin, and a certificate of health, necessary for export, and an export functioning unit, such as an exchange rate calculating unit, are added to the shipping data processing unit. Furthermore, prices in a foreign currency including at least the American dollar except yen, converted from the prices of the fishes and shellfishes, and the documents, such as the invoice with the prices, necessary for the export are prepared by driving the export document preparing unit. Thus, fishes and shellfishes for which an order has been received from an overseas customer can be promptly packed and shipped from the management section to the overseas customer. The display for the foreign language may include display of the foreign language and Japanese or display of the foreign language, Japanese, English, and the like.

In particular, according to the present invention, the preparation for the documents necessary for the export can be processed in the system according to the present invention. The stocking of the fishes and shellfishes for which the order has been received, the packing and shipping for overseas can be performed with an amount of work substantially the same as that of the packing and the shipping for domestic customers. Although the packing and the shipping for overseas is a race against time of whether the packing and the shipping are in time for departure times of cargo air services, this problem can be overcome. Note that, for example, the broker who operates and manages the order receiving server may serves as the above fish and shellfish section. Alternatively, a trader who is different from the broker may be in charge of the above fish and shellfish section. Even when any of them is in charge of the above fish and shellfish section, there is no difference in contents of an embodiment of the present invention.

### Advantageous Effects of Invention

In the ordering and order receiving system according to the present invention, the commodity information display instructing unit displays the commodity information selected based on the customer classification for the commodity information to be displayed on each screen of the ordering clients. The selected commodity information is the commodity information selected based on the categories of the fishes and shellfishes, the classification of customer orientation, the prices, and the like. Therefore, the transaction type can be made to be achieved by only the ordering and order receiving system according to the present invention, including the order receiving server and the ordering clients.

The ordering and order receiving system can be made so as to handle the order from the united ordering client uniting the plurality of customers. Thus, for example, ordering for each store from a franchisee head office that deploys the plurality of stores is collectively handled. For example, packing and shipping can be performed to each of the stores. A shipping document and a transaction document, such as a statement of delivery and a bill, can be collectively issued to the head office.

Furthermore, in order to handle the order from overseas, the commodity information displayed on each client screen by the commodity information display instructing unit can be displayed by switching between Japanese and the foreign language including at least English except the Japanese. In a case where the commodity information is displayed in the foreign language except Japanese on each client screen, the preparing unit for the documents at least, such as the invoice, necessary for the export, and the export functioning unit, such as the exchange rate calculating unit, are added to the shipping data processing unit. The prices in the foreign currency including at least the American dollar except yen, converted from the prices of the fishes and shellfishes in yen terms, and the documents, such as the invoice with the prices in the foreign currency, necessary for the export can be prepared. Thus, the order from overseas can be easily handled.

### BRIEF DESCRIPTION OF DRAWINGS

FIG. 1 is a block diagram of an exemplary entire configuration of an ordering and order receiving system according to the present invention.

FIG. 2 is a block diagram of an exemplary configuration of an order receiving server in the ordering and order receiving system in FIG. 1.

FIG. 3 is a block diagram of an exemplary configuration of an ordering client in the ordering and order receiving system in FIG. 1.

FIG. 4 is a flow chart of a flow of processing in the ordering and order receiving system according to the present invention.

### DESCRIPTION OF EMBODIMENTS

Next, an ordering and order receiving system according to an embodiment of the present invention will be described with reference to the drawings.

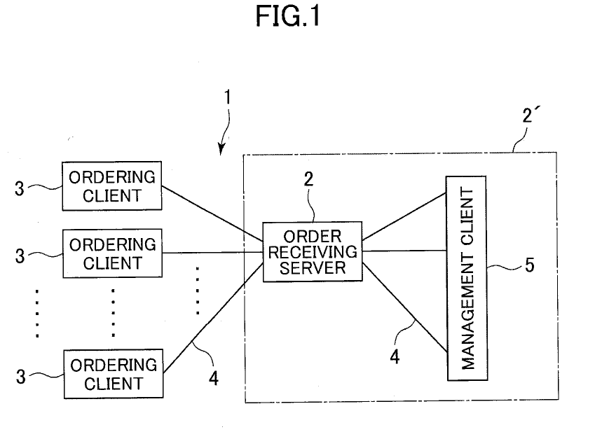

In FIG. 1, reference numeral 1 denotes the ordering and order receiving system according to the present invention. Reference numeral 2 denotes an order receiving server managed and operated by a broker as an example. Reference numeral 3 denotes an ordering client included in each of a plurality of customers. Reference numeral 4 denotes a communication network including the Internet, capable of coupling the order receiving server 2 and the respective ordering clients 3 to be communicable. Reference numeral 5 denotes a management client in a fish and shellfish management section, such as the broker, another broker, or a delivery company, the management client being coupled to the order receiving server 2 through a network 4 the same as the above network 4. Note that the client 5 in the management section may be one of a plurality of management clients 5.

The fish and shellfish management section performs a distribution service including stocking, such as stocking of the amount of fishes and shellfishes ordered by each of the customers, and a sale, such as handling, packing, and shipping of the stocked fishes and shellfishes for each of the customers, based on stocking data and shipping data input from the order receiving server 2 to the client 5 that is a terminal computer.

In the ordering and order receiving system 1 according to the present invention in FIG. 1, a sushi bar, a tavern, a restaurant, and the like each are defined as an exemplary customer. Fresh fishes and shellfishes daily used by the places to eat and the like are defined as objects to be ordered and received. A terminal computer included in each of the customers is defined as the ordering client 3. A server computer operated and managed by, for example, the broker who stocks fishes and shellfishes ordered by each of the customers, from a market and provides a store of each of the customers with the fishes and shellfishes, is defined as the order receiving server 2. According to the present example, the fish and shellfish management section stocks the amount of fishes and shellfishes ordered on that day, from a market or the like, and performs packing and shipping to each of the customers, based on the stocking data and the shipping data formed in the order receiving server 2. Therefore, a computer of the management trader is the management client 5 in the fish and shellfish management section in the present example. Note that, for example, the server 2 of the broker who is a trader operating and managing the order receiving server 2, can serve as the management client 5 in the management section (refer to an order receiving server 2′ surrounded with a chain line in FIG. 1).

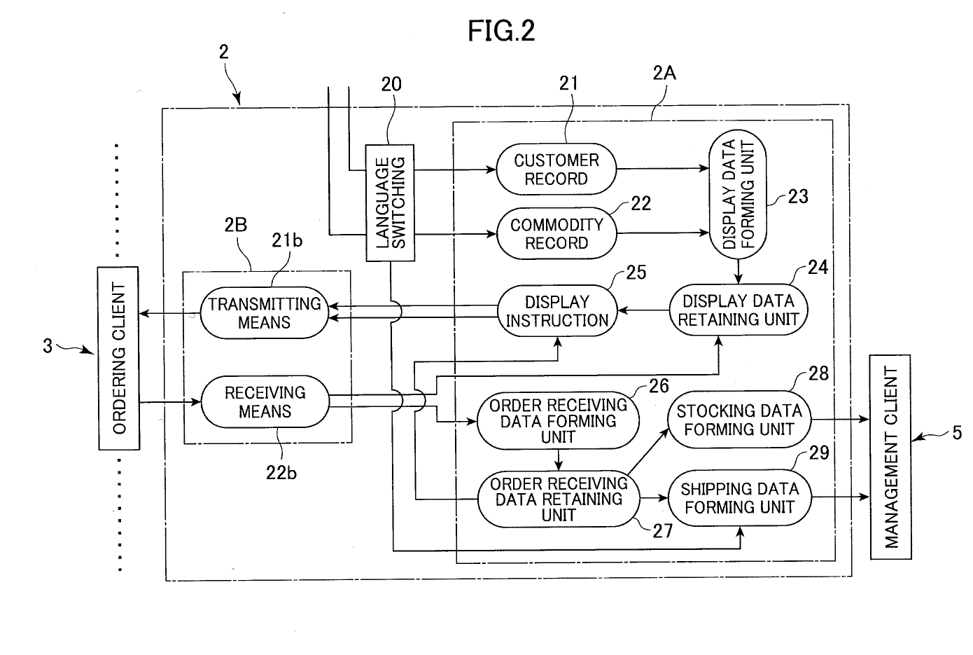

In FIG. 2, the order receiving server 2 includes an order receiving terminal 2A and a communication unit 2B. The order receiving terminal 2A receives an order from the client 3 of each of the customers. The order receiving terminal 2A includes a customer recording means 21, a commodity recording means 22, a commodity information selecting unit 23, a display data retaining unit 24, a commodity information display instructing unit 25, an order receiving data forming unit 26, an order receiving data retaining unit 27, a stocking data forming unit 28, and a shipping data forming unit 29. The customer recording means 21 records and retains, as rewritable customer information, information including customer classification based on attributes of a category of business of each of the customers (for example, a sushi bar, a tavern, and a restaurant) , and a scale (for example, types and the number of fishes and shellfishes consumed on the average in a day), or a store location (hereinafter, these are referred to as the attributes), the information being provided from the outside of the server 2, such as each ordering client 3. For fishes and shellfishes that can be provided to each ordering client 3 today, the commodity recording means 22 records and retains, as rewritable commodity information, categories (for example, live fish, raw fish, and dried fish) , figures, names, and sizes (for example, volume and weight) for every category, classifications of seasonal fish and standard fish, commodity character, such as prices (including a unit price), production regions, and processing places. The commodity information selecting unit 23 selects the commodity information based on the customer classification. The display data retaining unit 24 retains the commodity information selected by the selecting unit 23, based on each ordering client 3. The commodity information display instructing unit 25 displays display data of the retaining unit 24 on a terminal screen of each ordering client 3. The order receiving data forming unit 26 forms, as order receiving data, an order of every client, based on ordering data formed with the commodity information, as the order, input by each ordering client 3. The order receiving data retaining unit 27 retains the order receiving data formed for every client. The stocking data forming unit 28 forms stocking data by processing a plurality of different types of fishes and shellfishes to be stocked based on the order receiving data of the retaining unit 27 and an amount of stocking of each of the plurality of different types of fishes and shellfishes. The shipping data forming unit 29 prepares documents including a shipping direction, a statement of delivery, a bill, and the like, necessary for shipping, based on the order receiving data. The stocking data and the shipping data are provided to the management client 5 in the fish and shellfish management section. The order receiving terminal 2A and the management client 5 are typical computers, namely, electronic computers each having a configuration including a CPU, a memory, a storage device, input/output devices, and the like, coupled to each other through a bus.

The communication unit 2B in the order receiving server 2 includes a transmitting means 21b and a receiving means 22b. The transmitting means 21b transmits the commodity information for each of the customers, retained in the commodity information display instructing unit 25 based on the customer classification, to each client 3. The receiving means 22b receives the ordering data (commodity information on fishes and shellfishes) sent from each client 3. Note that, the order receiving data retaining unit 27 is coupled to the transmitting means 21b through the display supporting unit 25. The order receiving data formed on the side of the order receiving server, is displayed on the screen of each ordering client 3. The receiving means 22b is coupled to the order receiving data forming unit 26.

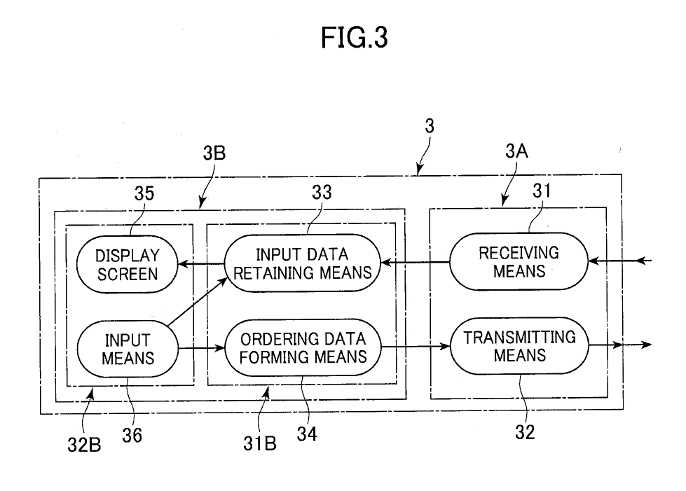

In FIG. 3, each ordering client 3 includes a communication unit 3A and an ordering terminal 3B including at least a control unit 31B and a display unit 32B. The communication unit 3A includes a receiving means 31 and a transmitting means 32. The control unit 31B includes an input data retaining unit 33 and an ordering data forming means 34. The input data retaining unit 33 retains the commodity information sent from the order receiving server 2, received by the receiving means 31. The ordering data forming means 34 forms, as ordering data, an input signal from an input means 36 to be described later. The display unit 32B includes a display screen 35 and the input means 36. The display screen 35 displays the commodity information that has been retained. The input means 36 selects and inputs, as the ordering data, commodity information on fishes and shellfishes, desired by the customer of each client 3, from the commodity information of fishes and shellfishes displayed on the screen 35. Note that, in a case where the input means 36 includes a touch panel, the input means 36 has a configuration so as to overlap the screen 35 (laminated layer).

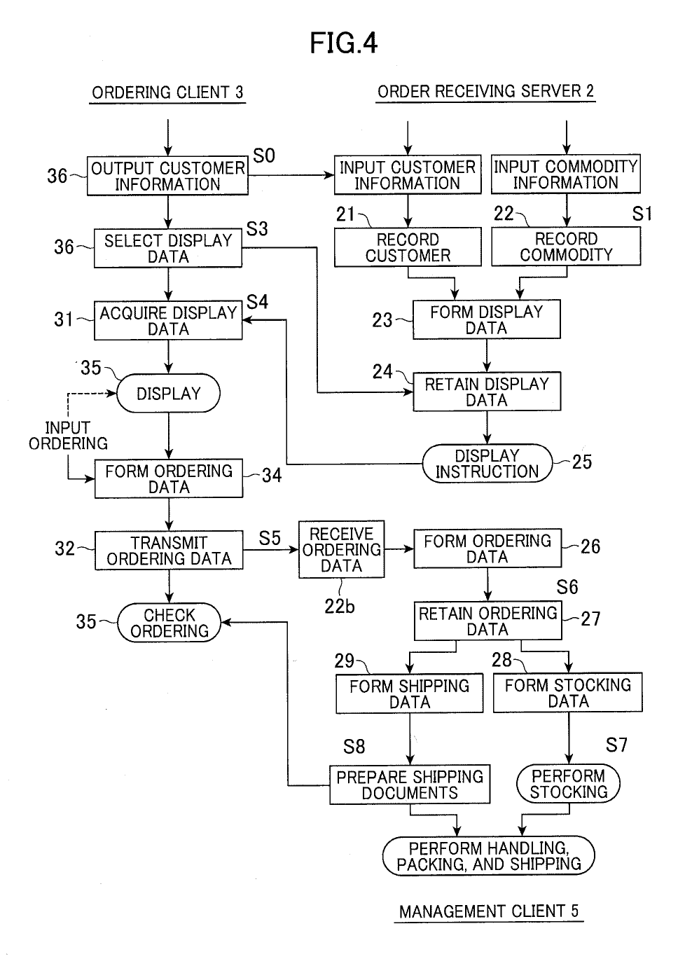

Next, an exemplary operation flow relating to, for example, the order receiving server 2 of the broker, the ordering client 3 of each of the customers, and the management client 5 in the fish and shellfish management section, will be described with reference to FIG. 4.

When the order receiving server 2 starts, data of the customer information relating to the attributes of each of the customers, and the like, and data of the commodity information relating to the categories, the prices of fishes and shellfishes, and the like, are input and retained in the recording units 21 and 22, respectively, at step S1. Here, the customer information is formed of customer data output from the ordering client 3 and customer data input in the order receiving server 2 by the facility manager at step S0.

Each of the pieces of data in the two recording units 21 and 22 is formed so as to be the display data to be displayed on the display screen 35 of each ordering client 3 in the display data forming unit 23 at step S2. The retaining unit 24 retains the display data. The display data is formed, for example, for the individual categories of fishes and shellfishes (for example, wild fish, farmed fish, fish for sashimi, and fish for sushi) .

Meanwhile, the ordering client 3 operates the input means 36, forms an instruction for selecting display data of a content to be displayed on the client screen 35 with respect to the display data retaining unit 24 of the order receiving server 2, and dispatches the instruction from the transmitting means 32 to the order receiving server 2 (step S3) . The display data selected by the ordering client 3 in the display data retaining unit 24 is input into the input data retaining unit means 33 of the client 3 through the receiving means 31. Thus, the ordering client 3 acquires the display data (step S4).

The ordering client 3 that has acquired the display data displays the acquired display data on the client screen 35. The customer watches the screen display, selects fishes and shellfishes to be ordered, and performs an ordering input through the input means 36. The ordering input is formed so as to be the ordering data in the data forming unit 34 of the client 3. The transmitting means 32 included in the client 3 transmits the ordering data to the order receiving data forming unit 26 of the order receiving server 2 (step S5) . The data forming unit 26 that has received the ordering data, forms the order receiving data there. Then, the retaining unit 27 retains the formed order receiving data (step S6).

The order receiving data that has been retained is provided to each of the stocking data forming unit 28 and the shipping data forming unit 29.

The stocking data forming unit 28 forms, as a stocking report, order receiving data of all the customers on that day, for example, stocking data indicating an amount of stocking for each commodity by aggregating fishes and shellfishes specified with commodity codes every commodity (step S7).

Meanwhile, the shipping data forming unit 29 prepares information necessary for packing and shipping for each of the customers, namely, the statement of delivery and the bill necessary for the shipping, in addition to the shipping direction, an exclusive order form. The shipping direction clearly states which of stocked fishes are fishes to be packed and shipped for each of the customers. The exclusive order form is an in-house direction that instructs names, destinations, types of packing, and the like, of fishes to be picked and fishes to be packed from the fishes and shellfishes that have been stocked. The shipping data forming unit 29 may form and retain data necessary for preparing the respective documents instead of preparing the respective documents. The retained data is used when the management client 5 prepares a shipping document. Note that, overseas shipping data is basically similar to home shipping data. The shipping data forming unit 29 stores data including, for example, a format and a template of each document in overseas peculiar documents, such as an invoice, a packing list, a certificate of origin, and a certificate of health, that may be different every country. When the ordering and order receiving system according to the present invention switches for overseas, necessary items are input into blanks of typical documents necessary for export regarding each overseas customer and blanks of documents different in countries of the respective customers. Then, documents for the export are formed (step S8) .

According to the present invention, the order receiving data (shipping data) for each of the customers is transmitted to each client 3. Thus, each of the customers can check its own ordering content (step S9).

The pieces of data formed in the two data forming units 28 and 29 are output to the management client 5 in the fish and shellfish management section. The fish and shellfish management section including the client 5 stocks the fishes and shellfishes required to be shipped to each of the customers from a market and the like, based on the stocking data (stocking report), packs the fishes and shellfishes with contents in accordance with the shipping direction, and ships the fishes and shellfishes to each of the customers with the necessary shipping document including the statement of delivery, the bill, and the like, attached.

The exemplary ordering and order receiving of fish and shellfish has been given in the above descriptions in a case where the ordering client 3 is a customer whose whereabouts is in Japan. The ordering and order receiving system according to the present invention can be also applied to a case where a customer is a foreign corporation or an individual resident abroad and the customer is a person using a language except Japanese.

That is, a display language indicating information exchanged between the order receiving terminal 2A in the order receiving server 2 and the ordering terminal 3B of the ordering client 3, is displayed by switching to a foreign language including at least English, translated from Japanese used in the above example, is displayed in both Japanese and the foreign language, or is displayed in only the foreign language. The switching selection of an applying language can be performed in a language selecting unit 20 from any example of the order receiving server 2 and the ordering client 3. The language switching in FIG. 2 is performed in the exemplary language selecting unit 20 disposed at a pre-stage of the two recording units 21 and 22 of the order receiving server 2. As not illustrated, the language switching can be freely performed in the ordering terminal 3B. When the language selecting unit 20 selects the foreign language, a selection signal is also output to the shipping data forming unit 29. Then, an export document preparing unit for the invoice, and the like, and an exchange calculating unit (not illustrated), included in the shipping data forming unit 29, are started. Preparation for an export document, such as an invoice, in the language to be used, and a transaction document, such as a bill, based on currency within regions of the foreign language to be used, can be made.

In the ordering and order receiving of fish and shellfish according to the present invention, the following ordering and order receiving types can be made in a case where a customer has a franchisee head office that operates and deploys a plurality of stores. First, an ordering client 3 is prepared to be included in each of the stores. The client 3 in each of the stores places an order with respect to the order receiving server 2. Meanwhile, based on customer data relating to the respective stores and the franchisee head office, the order receiving server 2 causes the fish and shellfish management section to prepare a shipping direction, a statement of delivery, and the like, for each of the stores and to perform packing and shipping to each of the stores with respect to the order from each of the stores. In addition, the order receiving server 2 causes the fish and shellfish management section to send a statement of delivery and the like (or a unified statement of delivery) the same as the statement of delivery for each of the stores and a unified bill, to the franchisee head office. This is one type in the ordering and order receiving types.

Alternatively, an ordering client 3 disposed in the franchisee head office orders fishes and shellfishes required for each of the stores from the order receiving server 2. Similarly to a case where an order is placed from each of the stores, the order receiving server 2 that has received the order, causes the management section to prepare a shipping document including a shipping direction, a statement of delivery, and a bill, and to perform packing and shipping for each of the stores . In addition, the order receiving server 2 causes the management section to send a copy of the shipping document for each of the stores to the head office. This is another type in the ordering and order receiving types.

The present invention has been described above. The order (ordering) and the order receiving of fresh fish and shellfish are performed with the electronic data between the client included in each of the customers and the server included in the present system operator through the network. Thus, each of the customers can order and receive fishes and shellfishes without visiting a market for purchase.

The ordering and order receiving system for fish and shellfish according to the present invention is based on the electronic data. An alteration and cancellation of ordering can be freely made from an order receiving starting time (for example, 15 o'clock on the previous day) to an ordering closing time (for example, 1 a.m. for domestic customers and 0 a.m. for overseas customers are generally arranged, but 2 a.m. or the like can be arranged, depending on customers). Thus, each of the customers can sufficiently examines the commodity information relating to fishes and shellfishes displayed on the client terminal, and receives necessary fishes and shellfishes without visiting the market.

In particular, for export with respect to overseas customers who desire to relish fishes and shellfishes in Japan, the electronic ordering and order receiving system according to the present invention, prepares a necessary export document, such as an invoice, necessary for the export, in the system, and then completes the preparation for the necessary document by the time that packing is performed. Thus, prompt packing and shipping to be in time for departure times of cargo air services can be made. A particular effect with which fresh fishes and shellfishes on the day the same as those received by customers within Japan, can be easily received and relished abroad, can be acquired.

### REFERENCE SIGNS LIST

1 ordering and order receiving system according to the present invention
2 order receiving server
3 ordering client
4 network
5 management client

1. An ordering and order receiving system for fish and shellfish, comprising:
an order receiving server configured to produce commodity information on fishes and shellfishes that can be provided to ordering clients of a plurality of customers on that day (from 15 0'clock on the previous day to 1 0'clock or 2 0'clock on the day) , the order receiving server configured to form order receiving data based on ordering data of each of the customers , formed by specifying desired fishes and shellfishes through the individual clients by the customers who have watched the produced information, the order receiving server configured to form stocking data on the day and shipping data for each of the customers based on the order receiving data, the order receiving server configured to output the stocking data and the shipping data for each of the customers to a fish and shellfish management section that stocks the fishes and shellfishes and that packs and ships the stocked fishes and shellfishes; and the ordering clients of the plurality of customers configured to output the ordering data specifying the desired fishes and shellfishes based on the commodity information produced on a client screen of each of the customers by the order receiving server, to the server, wherein the order receiving server includes:
a recording unit for customer information including customer classification formed based on customer attributes, such as a category of business, a scale, and a location of each of the customers being the ordering clients; a recording unit for the commodity information including categories of the fishes and shellfishes, commodity character, such as figures, names, sizes, prices, and places of origin in each of the categories, and classification information, such as seasonal fish, standard fish, and recommended fish, the commodity information being produced to the clients; a commodity information selecting unit configured to select commodity information to be displayed on the client screen of each of the customers based on the customer information and the commodity information in the recording units ; a display instructing unit configured to display the selected commodity information on the client screen; an order receiving data forming unit configured to form and retain the order receiving data per unit customer by associating the ordering data with the customer information for the order, the ordering data being selected from the commodity information displayed on the screen and being output from the clients ; a stocking data forming unit configured to form the stocking data of the fishes and shellfishes required to be stocked based on the order receiving data per unit customer; a shipping data processing unit configured to form the shipping data for preparing at least a shipping direction, a statement of delivery, and a bill for each of the customers based on the order receiving data; and a communication unit coupled to output of the display instructing unit, the order receiving data processing unit, and the shipping data processing unit, and when each of the ordering clients inputs the ordering data into the order receiving server, the server forms the order receiving data based on the customer information according to the ordering data and the commodity information on the fishes and shellfishes for which the order has been received, and also forms the stocking data and the shipping data based on the order receiving data so as to output the pieces of data to a management client in the fish and shellfish management section, the management client configured to prepare at least the shipping direction, the statement of delivery, and the bill, or a document equivalent to the documents for the fishes and shellfishes for which the order has been received from each of the customers, the management client configured to form a stocking instruction for the fishes and shellfishes for which the order has been received, based on the input stocking data and shipping data, the management section configured to pack and ship the fishes and shellfishes that have been stocked based on the instruction, to each of the customers .

2. The ordering and order receiving system for fish and shellfish according to claim 1, wherein the commodity information display instructing unit displays the commodity information selected and processed for each of the customers based on the customer classification, for the commodity information to be displayed on the screen of each of the ordering clients.

3. The ordering and order receiving system for fish and shellfish according to claim 2, wherein the commodity information to be selected is the commodity information selected based on any of the categories of the fishes and shellfishes, the classification information of customer orientation, such as seasonal fish, standard fish, and recommended fish, and the prices of the fishes and shellfishes, or a combination thereof.

4. The ordering and order receiving system for fish and shellfish according to claim 1, wherein the ordering clients of the plurality of customers are combined into one so as to be considered to be one united client, the ordering data is formed per unit united customer, and the shipping data is united with the order receiving data per unit customer, the shipping data being formed to be one shipping direction, one statement of delivery, and one bill, or a document equivalent thereto, the shipping data being output to the management client in the fish and shellfish management section.

5. The ordering and order receiving system for fish and shellfish according to claim 1, wherein the commodity information displayed on each client screen by the commodity information display unit is displayed by switching between Japanese and a foreign language including at least English.

6. The ordering and order receiving system for fish and shellfish according to claim 5, wherein when the commodity information is displayed on each client screen in the foreign language including English except Japanese, a preparing unit for export documents at least , such as an invoice, a packing list, a certificate of origin, and a certificate of health, necessary for export, and an export functioning unit, such as an exchange rate calculating unit, are added to the shipping data processing unit, and prices in a foreign currency converted from the prices of the ordered fishes and shellfishes into a currency except yen, and the necessary documents, such as the invoice, with the prices in the foreign currency are prepared so as to be output to the fish shellfish management section.

7. The ordering and order receiving system for fish and shellfish according to claim 2, wherein the ordering clients of the plurality of customers are combined into one so as to be considered to be one united client, the ordering data is formed per unit united customer, and the shipping data is united with the order receiving data per unit customer, the shipping data being formed to be one shipping direction, one statement of delivery, and one bill, or a document equivalent thereto, the shipping data being output to the management client in the fish and shellfish management section .

8. The ordering and order receiving system for fish and shellfish according to claim 3, wherein the ordering clients of the plurality of customers are combined into one so as to be considered to be one united client, the ordering data is formed per unit united customer, and the shipping data is united with the order receiving data per unit customer, the shipping data being formed to be one shipping direction, one statement of delivery, and one bill, or a document equivalent thereto, the shipping data being output to the management client in the fish and shellfish management section .

9. The ordering and order receiving system for fish and shellfish according to claim 2, wherein the commodity information displayed on each client screen by the commodity information display unit is displayed by switching between Japanese and a foreign language including at least English.

10. The ordering and order receiving system for fish and shellfish according to claim 3, wherein the commodity information displayed on each client screen by the commodity information display unit is displayed by switching between Japanese and a foreign language including at least English.

11. The ordering and order receiving system for fish and shellfish according to claim 4, wherein the commodity information displayed on each client screen by the commodity information display unit is displayed by switching between Japanese and a foreign language including at least English.
